(19) United States
(12) Patent Application Publication
(10) Pub. No.: US 2026/0371238 A1
(43) Pub. Date: Nov. 19, 2026

(54) eDRX Enhancements for Reduced Capability User Equipment

(71) Applicant: Apple Inc., Cupertino, CA (US)

(72) Inventors: Jie CUI, San Jose, CA (US); Dawei ZHANG, Saratoga, CA (US); Hong HE, San Jose, CA (US); Konstantinos SARRIGEORGIDIS, Los Gatos, CA (US); Naveen Kumar R PALLE VENKATA, San Diego, CA (US); Yang TANG, San Jose, CA (US)

(21) Appl. No.: 19/481,706

(22) PCT Filed: Apr. 30, 2024
(86) PCT No.: PCT/US2024/027017

§ 371 Date: Nov. 5, 2025

Related U.S. Application Data
(60) Provisional application No. 63/500,320, filed on May 5, 2023.

(51) Int. Cl. H04W 48/20; H04W 48/16; H04W 76/28

(52) U.S. Cl. CPC H04W 48/20; H04W 48/16; H04W 76/28

(57) ABSTRACT

An apparatus configured to perform a cell reselection procedure from an original serving cell to a target neighbor cell, wherein completion of the cell reselection procedure results in the target neighbor cell becoming a new serving cell (NSC), the cell reselection procedure comprising reading system information of the target neighbor cell, wherein the system information comprises an enhanced discontinuous reception (eDRX) configuration of the target neighbor cell, monitor paging occasions for the original serving cell while performing the cell reselection procedure for the target neighbor cell and when the cell reselection procedure is complete, monitor paging occasions for the NSC based on the eDRX configuration from reading the system information of the target neighbor cell.

### PRIORITY/INCORPORATION BY REFERENCE

This application claims priority to U.S. Provisional Application Ser. No. 63/500,320 filed on May 5, 2023 and entitled, “eDRX Enhancements for Reduced Capability User Equipment,” the entirety of which is incorporated herein by reference.

### BACKGROUND

A new radio (NR) network may support reduced capability (redcap) user equipment (UEs). Generally, a redcap UE is not configured with the same features as non-redcap devices. Redcap UEs may provide cost and/or complexity reduction benefits.

Enhanced discontinuous reception (eDRX) is an energy saving network feature. However, different cells may or may not support eDRX operation. Redcap UE inactive mode and network operations when performing cell reselection between cells that have differing eDRX support should be defined to have a consistent operation in a network supporting both eDRX and redcap UEs.

### SUMMARY

Some example embodiments are related to an apparatus having processing circuitry configured to perform a cell reselection procedure from an original serving cell to a target neighbor cell, wherein completion of the cell reselection procedure results in the target neighbor cell becoming a new serving cell (NSC), the cell reselection procedure comprising reading system information of the target neighbor cell, wherein the system information comprises an enhanced discontinuous reception (eDRX) configuration of the target neighbor cell, monitoring paging occasions for the original serving cell while performing the cell reselection procedure for the target neighbor cell and when the cell reselection procedure is complete, monitor paging occasions for the NSC based on the eDRX configuration from reading the system information of the target neighbor cell.

Other example embodiments are related to an apparatus having processing circuitry configured to perform an ongoing cell detection/measurement/evaluation (DME) operation during a cell DME period based on at least a first enhanced discontinuous reception (eDRX) configuration of a serving cell and determine a change from the first eDRX configuration to a second eDRX configuration, wherein the change occurs during the cell DME period.

Still further example embodiments are related to an apparatus having processing circuitry configured to process, based on signals received from an original serving cell, a neighbor cell list comprising information for each neighbor cell on the neighbor cell list, perform cell detection, measurement, and evaluation for a target neighbor cell, associate with the target neighbor cell, wherein the target neighbor cell becomes a new serving cell (NSC) and determine whether the NSC is on the neighbor cell list.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows a first method diagram according to various example embodiments.

FIG. 5 shows a second method diagram according to various example embodiments.

### DETAILED DESCRIPTION

The example embodiments may be further understood with reference to the following description and the related appended drawings, wherein like elements are provided with the same reference numerals. The example embodiments relate to enhanced eDRX operations for redcap UEs.

The example embodiments are described with regard to a UE. However, reference to a UE is merely provided for illustrative purposes. The example embodiments may be utilized with any electronic component that may establish a connection to an accessory device and is configured with the hardware, software, and/or firmware to exchange information and data with accessory devices. Therefore, the UE as described herein is used to represent any electronic component.

The example embodiments are also described with reference to a 5G New Radio (NR) network. However, the example embodiments may also be implemented in other types of networks, including but not limited to LTE networks, future evolutions of the cellular protocol, or any other type of network.

Cell discontinuous reception (DRX) and enhanced discontinuous reception (eDRX) are network power saving modes. Power savings at the UE may be achieved by reduced neighbor cell measurements. Longer cell measurement times correspond with reduced UE energy use. Redcap UEs currently use three metrics for cell reselection: detection (T_{detect, NR_Intra_RedCap}), measurement (T_{measure, NR_Intra_RedCap}) , and evaluation (T_{evaluate, NR_Intra_RedCap}).

Existing cell reselection operations for a UE in the inactive mode (e.g., Radio Resource Control (RRC) Inactive Mode) have the UE first detect a target cell, measure the target cell, and evaluate the target cell. Existing implementations do not have the UE acquire/evaluate eDRX information from the target cell.

Different cells in the same tracking area may have different eDRX configurations (e.g., some cells may or may not support/allow eDRX). A redcap UE (henceforth “UE”) operating in such a tracking area should understand the eDRX configuration of a newly selected cell during cell selection.

Throughout this description, it will be described that a cell (serving cell or target neighbor cell) has a eDRX configuration. In general, the eDRX configuration indicates whether the cell supports eDRX operations. However, the term eDRX configuration may also be used to refer to a status of an eDRX configuration of the cell. That is, a cell may support eDRX operation, but in certain instances the cell may not currently have eDRX active. Thus, any description of a change to an eDRX configuration may also refer to a change in the status of an eDRX configuration of a cell.

Providing an indication of the cell eDRX configuration will allow a UE to understand the resources to monitor for paging occasions of a target cell. The example embodiments relate to cell reselection operations when redcap UEs are reselecting between cells supporting different types of DRX and/or eDRX operations including providing the UE with eDRX configuration information for the target cell or defining operations for the UE when the eDRX configuration of the target cell is unknown. Other example embodiments are related to redefining the cell reselection procedure to include reading system information that includes the eDRX configuration for the target cell so that the UE has the eDRX configuration before using the target cell as a serving cell. Further example embodiments are related to a UE performing cell detection/measurement/evaluation operations when a transition between different eDRX configurations is detected. Each of these example embodiments are described in greater detail below.

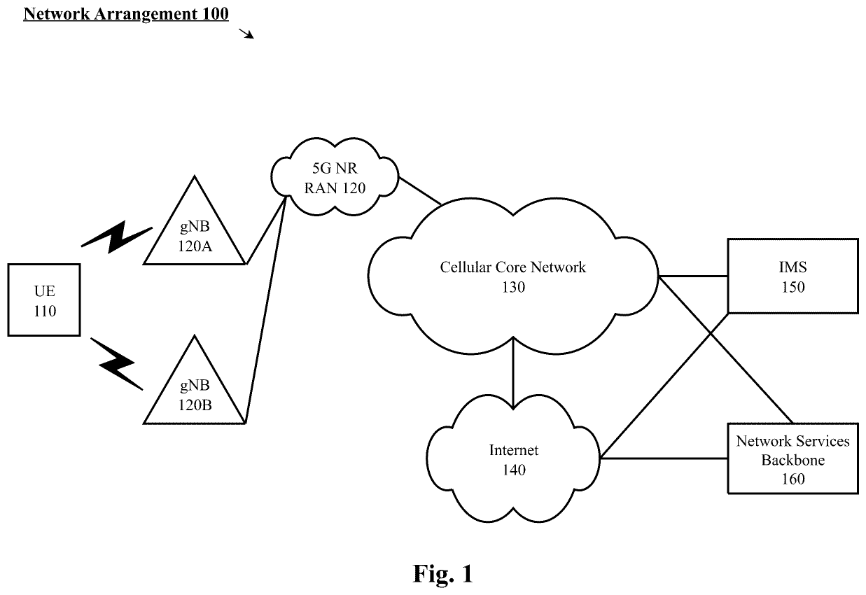

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of one UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120.

Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A). There may also be one or more neighboring cells with which the UE may communicate with prior to a handover operation. One additional neighbor cell is shown in FIG. 1 with gNB 120B, but one of skill in the art will recognize that a UE may have more than one neighbor cells available for handover.

The gNB 120B may have a different eDRX configuration than the gNB 120A. Throughout the example embodiments, the gNB 120A may be understood to be the serving cell. The gNB 120A may also be referred to as the former serving cell or the original serving cell. The gNB 120B may be referred to as a target cell, or the gNB 120B may also be referred to as the new serving cell (NSC).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

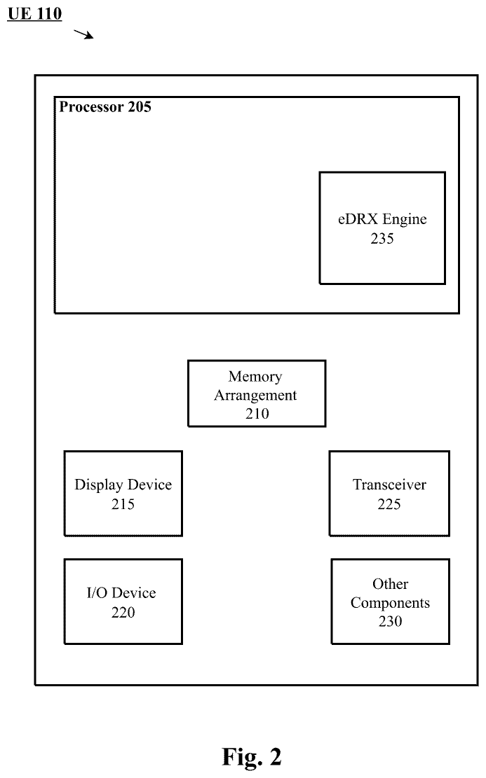

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an eDRX engine 235 for performing operations related to determining the behavior of the UE 110 with respect to eDRX configurations of one or more target neighbor cells.

The above referenced engine being an application (e.g., a program) executed by the processor 205 is only example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

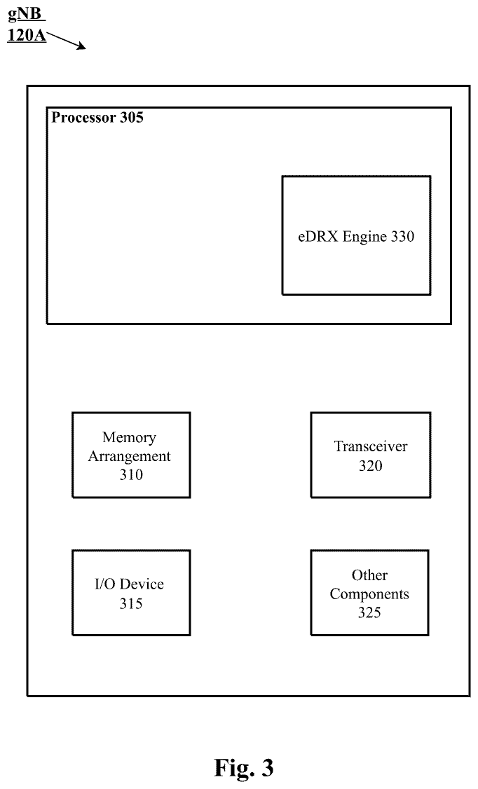

FIG. 3 shows an example base station 300 according to various example embodiments. The base station 300 may represent the gNB 120A (or the gNB 120B) or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a cell selection engine 330 for performing operations related to transmission of information (e.g., system information) that the UE 110 will use to determine an eDRX configuration when moving to a target cell (e.g., the gNB 120B).

The memory arrangement 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100.

The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

In a first aspect of the example embodiments, UE inactive mode eDRX logic is disclosed. In the first aspect, a serving cell (e.g., the gNB 120A) broadcasts an inactive mode eDRX configuration/status of a target neighbor cell (e.g., qNB 120B) for the UE 110.

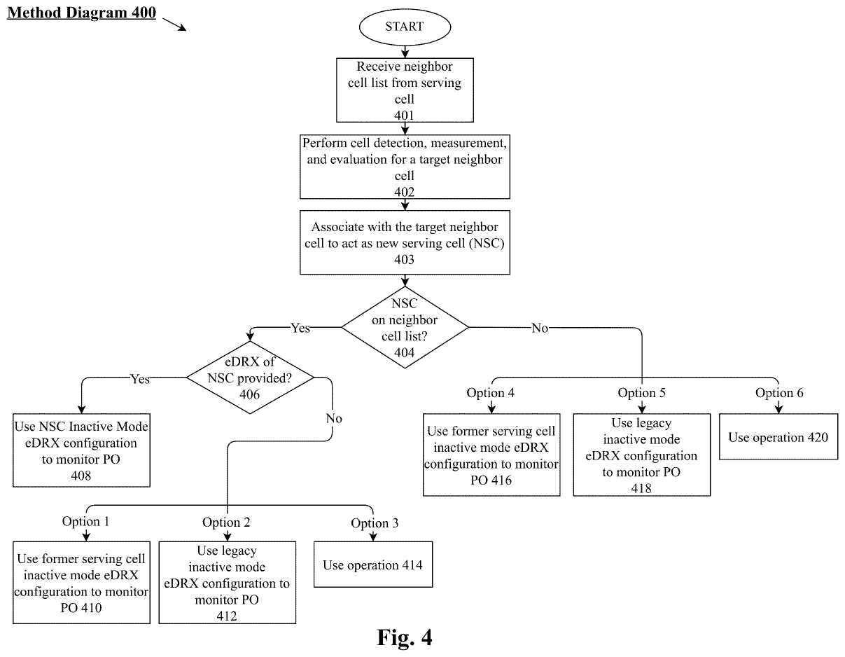

FIG. 4 shows a first method diagram 400 according to various example embodiments. Method diagram 400 may be understood to describe the first aspect.

In 401, the UE 110 receives a neighbor cell list containing candidate cells for cell reselection from the serving cell gNB 120A in the system information (SI). Each neighbor cell in the list may indicate an inactive mode eDRX configuration and/or status (henceforth “configuration”) of each neighbor cell to the UE 110.

In 402, the UE 110 performs cell detection, measurement and evaluation (hereinafter “DME”) of a target neighbor cell gNB 120B. The target cell DME may comprise operations that are performed during a cell reselection procedure including detecting the target cell, performing measurements on reference signals (RSs) transmitted by the target cell and evaluating the measurements to determine if the target cell should become the new serving cell for the UE 110. It is assumed for the purposes of the method diagram 400 that the target neighbor cell gNB 120B passes the UE DME procedure, e.g., the UE 110 decides to associate with the target neighbor cell gNB 120B to become the new serving cell.

In 403, the UE 110 associates with the target neighbor cell gNB 120B to act as a new serving cell. It should be noted that at the conclusion of 403, the gNB 120A is no longer the serving cell of the UE 110, instead, the gNB 120B is now the new serving cell (NSC).

In 404, the UE 110 determines whether the NSC gNB 120B is on the neighbor cell list received in 401. If the NSC gNB 120B is on the list, the UE 110 proceeds to 406. If the NSC gNB 120B is not on the list, the UE 110 proceeds to one of 416, 418, or 420. Each of these options will be described in greater detail below.

Not every neighbor cell on the list may have an eDRX configuration, e.g., the original serving cell gNB 120A may be unaware of the eDRX configuration of one or more of the target neighbor cells on the list. The example embodiments provide UE logic to handle both possible scenarios. In 406, the UE 110 determines whether the NSC gNB 120B on the neighbor cell list has an eDRX configuration. This determination allows the UE 110 to understand if the NSC cell gNB 120B allows/supports enhanced inactive mode eDRX.

In 408, if the NSC gNB 120B on the neighbor cell list has an eDRX configuration, the UE 110 uses the inactive mode eDRX configuration to monitor paging occasions (PO) after cell DME operations, e.g., the UE 110 is aware of the eDRX configuration of the NSC gNB 120B and may operate in accordance with this eDRX configuration. For example, the inactive eDRX configuration/status of the NSC gNB 120B may indicate whether the UE 110 should use legacy Inactive eDRX with a periodicity of less than or equal to 10.24 seconds or enhanced Inactive eDRX with a periodicity of greater than or equal to 20.48 seconds with a paging time window.

410, 412, and 414 are applicable if the NSC gNB 120B is on the neighbor cell list but does not have an eDRX configuration. The UE 110 uses one of three options (options 13, corresponding with 410, 412, and 414). The UE 110 may use one of the three options. The option that is selected may be defined by standards (e.g., 3GPP standards) or may also be signaled to the UE 110 in a configuration for the particular tracking area or network.

If the UE 110 is following option 1, the UE 110 proceeds to 410. In 410, the UE 110 uses the inactive mode eDRX configuration of the former serving cell, the gNB 120A, to monitor PO from the NSC gNB 120B.

If the UE 110 is following option 2, the UE 110 proceeds to 412. In 412, the UE 110 uses the legacy inactive mode eDRX (with a cycle periodicity≤10.24 s) operations to monitor PO from the NSC gNB 120B.

If the UE 110 is following option 3, the UE 110 proceeds to 414. In 414, the UE 110 monitors the former serving cell (the gNB 120A) paging occasion until the UE 110 completes an SI reading (e.g., SIB1 reading or any SIB that indicates the eDRX configuration of the NSC gNB 120B) of the NSC cell gNB 120B, e.g., until the UE 110 completes the SI reading of the NSC gNB 120B, the UE 110 does not monitor the NSC gNB 120B for POS but continues to monitor the original serving cell gNB 120A for POS. After the UE 110 completes the SI reading of the NSC gNB 120B, the UE 110 uses an inactive mode eDRX configuration or status of the NSC qNB 120B for PO monitoring.

Returning to 404, it is possible that one or more neighbor cells may not be on the neighbor cell list. If a neighbor cell is not on the neighbor cell list, the UE 110 proceeds to one of three options, 416, 418, or 420 (shown as options 4, 5, and 6). Again, the UE 110 may use one of the three options. The option that is selected may be defined by standards (e.g., 3GPP standards) or may also be signaled to the UE 110 in a configuration for the particular tracking area or network.

If the UE 110 is following option 4, the UE 110 proceeds to 416. In 416, the UE 110 uses the inactive mode eDRX configuration of the former serving cell, the gNB 120A, to monitor PO from the NSC gNB 120B.

If the UE 110 is following option 5, the UE 110 proceeds to 418. In 418, the UE 110 uses the legacy inactive mode eDRX (with a cycle periodicity≤10.24 s) operations to monitor PO from the NSC gNB 120B.

If the UE 110 is following option 6, the UE 110 proceeds to 420. In 420, the UE 110 monitors the former serving cell (the gNB 120A) paging occasion until the UE 110 completes an SI reading (e.g., SIB1 reading) of the NSC gNB 120B. After the UE 110 completes the SI reading of the NSC gNB 120B, the UE 110 uses an inactive mode eDRX configuration or status of the NSC gNB 120B for monitoring PO.

In a second aspect of the example embodiments, enhanced UE cell reselection procedures for RRC inactive mode are disclosed herein. A UE reads the SI (e.g., SIB1, or any SIB that indicates the eDRX configuration) of a target neighbor cell to acquire an eDRX configuration or status of that target neighbor cell during cell reselection. In the second aspect, cell reselection comprises cell detection, cell measurement, cell evaluation, and additionally, an SI reading.

The SI reading may include a master information block (MIB) reading, and/or a SIB1 reading. The SI reading would enable a UE to determine the eDRX status of a target neighbor cell directly.

A UE utilizing the second aspect may monitor the old serving cell POs until the UE completes cell reselection for the target neighbor cell (including selection, measurement, evaluation, and SI reading). After the completion of the cell reselection procedure, the UE 110 may follow the eDRX configuration/status of the target neighbor cell gNB 120B for PO monitoring. It should be noted that the target neighbor cell at the conclusion of the example cell selection procedure would be the new serving cell for the UE 110.

In a third aspect of the example embodiments, UE logic for selection of cells with different eDRX configurations/statuses is disclosed. The third aspect may also be applicable when a serving cell reconfigures its inactive mode eDRX status (e.g., the serving cell changes its status from allow enhanced inactive mode eDRX to not allow enhanced eDRX mode eDRX).

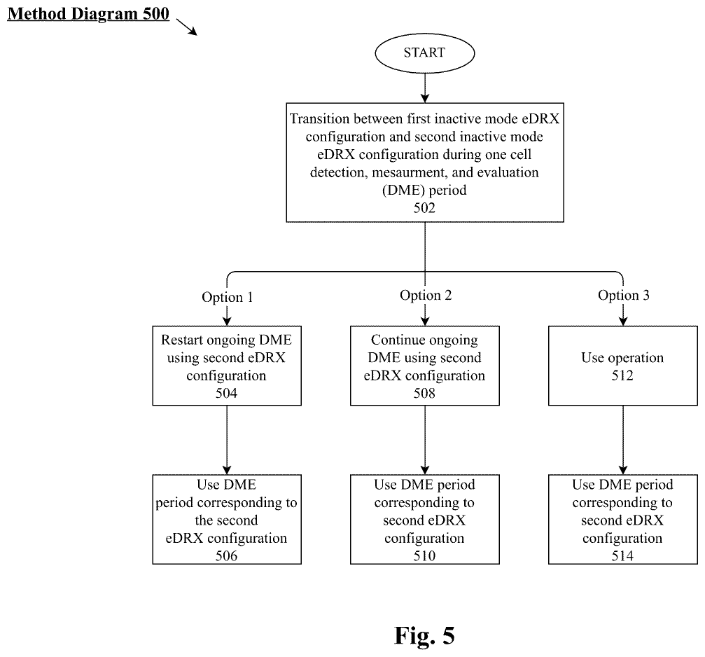

The third aspect may be further understood by reference to FIG. 5. FIG. 5 shows a second method diagram 500 according to various example embodiments. The method diagram 500 may be applicable to scenarios in which the UE 110 is operating in an RRC inactive mode and is performing cell reselection between two cells (a serving cell and target cell) that have different inactive mode eDRX configurations/statuses, or when the serving cell reconfigures its inactive mode eDRX status.

In 502, the UE 110 transitions between a first inactive mode eDRX configuration and a second inactive mode eDRX configuration during one cell DME period (whether cell to cell change or a same cell change). The first and second eDRX configurations may be different eDRX configurations. For example, the first eDRX configuration could be an enhanced configuration, and the second eDRX configuration may be a legacy configuration or vice versa. It should be noted that there is no particular importance to what type of eDRX configuration is first or second, the pertinent point is that the first and second eDRX configurations are different.

If the UE 110 is following option 1, the UE 110 proceeds to 504. In 504, the UE 110 may restart an ongoing DME operation using the second eDRX configuration including a DME period corresponding to the second eDRX configuration after the transition between the first and second eDRX configurations. In this option, restarting the DME means the UE 110 will drop or discard the old samples of the target neighbor cell DME and restart with all new samples after the eDRX configuration change, e.g., terminating the original DME and starting a new DME.

In 506, the UE 110 performs a new DME operation corresponding to the second eDRX configuration. This operation may be performed with or without a paging timing window (PTW).

One of skill in the art will recognize that use of PTW is dependent on the current eDRX configuration.

If the UE 110 is following option 2, the UE 110 proceeds to 508. Option 2 may be applicable to scenarios when the transition between the first and second eDRX configurations occurs in one of the following time frames. A first time frame is during a PTW of a legacy eDRX configuration. A second time frame is after the transition when the UE 110 is operating in a PTW window of the enhanced eDRX configuration. A third time frame is when the second eDRX configuration is a legacy eDRX configuration without PTW. Option 2 may be applicable to any of these types of transitions. As can be seen, each of these time frames is either when the UE 110 is operating in a PTW window (of either the legacy or enhanced eDRX configuration) or there is no PTW window. As will be described below, in these scenarios the samples collected using the first eDRX configuration may be combined with the samples collected using the second eDRX configuration because they should not be too remote in time, e.g., the samples will be collected closely in time because the samples are collected in a PTW window or there is no PTW window. To provide a contrasting scenario, if after the transition, the time frame is after a PTW window of the enhanced eDRX configuration, the next samples collected will not be until the next PTW window of the enhanced eDRX configuration. These samples may be too remote from the samples collected before the transition.

In 508, the UE 110 may continue with the ongoing DME operation using the second eDRX configuration after the transition. For the DME period corresponding to the ongoing DME operation, the UE 110 will use the first collected samples of the target cell qNB 120B DME operation (e.g., collected using the first eDRX configuration) to combine with the newly collected DME samples of the ongoing DME operation using the second eDRX configuration. Subsequent to this DME period, the UE 110 will use a DME operation corresponding to the second eDRX type with or without PTW, depending on the eDRX type.

In 510, the UE 110 uses a DME period corresponding to the second eDRX configuration. This operation may be performed with or without a paging timing window (PDW).

If the UE 110 is following option 3, the UE 110 proceeds to 512. In 512, the UE 110 may use the eDRX configuration which guarantees a longer DME period. The UE 110 may continue the ongoing DME operation using the guaranteed longer DME period after the transition as well. Continuing the DME operation in this case means that the UE 110 may use the first (i.e., old) collected samples of the target cell DME to combine with second (i.e., new) DME samples collected with the eDRX configuration which guarantees the UE 110 a longer DME period.

In 514, the UE 110 uses a DME period corresponding to the second eDRX configuration. This operation may be performed with or without paging timing window (PDW).

### Examples

In a first example, a method, comprising receiving, from an original serving cell, a neighbor cell list comprising information for each neighbor cell on the neighbor cell list, performing cell detection, measurement, and evaluation for a target neighbor cell, associating with the target neighbor cell, wherein the target neighbor cell becomes a new serving cell (NSC) and determining whether the NSC is on the neighbor cell list.

In a second example, the method of the first example, further comprising, when the NSC is on the neighbor cell list and when the information does not include an enhanced discontinuous reception (eDRX) configuration for the NSC, monitoring paging occasions for the NSC based on an eDRX configuration for the original serving cell.

In a third example, the method of the first example, further comprising, when the NSC is on the neighbor cell list and when the information does not include an eDRX configuration for the NSC, monitoring paging occasions for the NSC based on a legacy eDRX configuration with a cycle periodicity of less than or equal to 10.24 seconds.

In a fourth example, the method of the first example, further comprising, when the NSC is on the neighbor cell list and when the information does not include an eDRX configuration for the NSC, monitoring paging occasions from the original serving cell until a system information reading of the NSC provides an indication of the eDRX configuration for the NSC.

In a fifth example, the method of the first example, further comprising, when the NSC is on the neighbor cell list and when the information includes an eDRX configuration for the NSC, monitoring paging occasions for the NSC based on the eDRX configuration for the NSC.

In a sixth example, the method of the first example, further comprising, when the NSC is not on the neighbor cell list, monitoring paging occasions for the NSC based on an eDRX configuration for the original serving cell.

In a seventh example, the method of the first example, further comprising, when the NSC is not on the neighbor cell list, monitoring paging occasions for the NSC based on a legacy eDRX configuration with a cycle periodicity of less than or equal to 10.24 seconds.

In an eighth example, the method of the first example, further comprising, when the NSC is not on the neighbor cell list, monitoring paging occasions from the original serving cell until a system information reading of the NSC provides an indication of an eDRX configuration for the NSC.

In a ninth example, a processor configured to perform any of the methods of the first through eighth examples.

In a tenth example, a user equipment (UE) comprising a transceiver configured to communicate with a network and a processor communicatively coupled to the transceiver and configured to perform any of the methods of the first through eighth examples.

In an eleventh example, a method, comprising performing a cell reselection procedure from an original serving cell to a target neighbor cell, wherein completion of the cell reselection procedure results in the target neighbor cell becoming a new serving cell (NSC), the cell reselection procedure comprising, cell detection of the target neighbor cell, cell measurement of the target neighbor cell, cell evaluation of the target neighbor cell, and system information reading of the target neighbor cell, wherein the system information comprises an enhanced discontinuous reception (eDRX) configuration of the target neighbor cell, while performing the cell reselection procedure for the target neighbor cell, monitoring paging occasions for the original serving cell and when the cell reselection procedure is complete, monitoring paging occasions for the NSC based on the eDRX configuration from reading the system information of the target neighbor cell.

In a twelfth example, the method of the eleventh example, wherein the system information includes one or more of a master information block (MIB) or a system information block 1 (SIB1).

In a thirteenth example, a processor configured to perform any of the methods of the eleventh or twelfth examples.

In a fourteenth example, a user equipment (UE) comprising a transceiver configured to communicate with a network and a processor communicatively coupled to the transceiver and configured to perform any of the methods of the eleventh or twelfth examples.

In a fifteenth example, a method, comprising performing an ongoing cell detection/measurement/evaluation (DME) operation during a cell DME period based on at least a first enhanced discontinuous reception (eDRX) configuration of a serving cell and determining a change from the first eDRX configuration to a second eDRX configuration, wherein the change occurs during the cell DME period.

In a sixteenth example, the method of the fifteenth example, wherein the serving cell is an original serving cell and the change is based on a transition from the original serving cell to a new serving cell (NSC).

In a seventeenth example, the method of the sixteenth example, further comprising terminating the ongoing cell DME operation for the NSC, wherein the terminating includes discarding any measurement samples collected during the ongoing cell DME operation for the NSC and performing a new cell DME operation for the NSC during a new cell DME period based on the second eDRX configuration.

In an eighteenth example, the method of the sixteenth example, further comprising, when (i) the transition occurs during a legacy eDRX paging timing window (PTW), (ii) following the transition the UE is an enhanced eDRX PTW, or (iii) the second eDRX configuration does not include a PTW, continuing the ongoing cell DME operation for the NSC based on the second eDRX configuration, wherein samples collected prior to the transition using the first eDRX configuration are combined with samples collected after the transition using the second eDRX configuration and, after the cell DME period, performing subsequent DME operations for the NSC using a new DME period based on the second eDRX configuration.

In a nineteenth example, the method of the sixteenth example, further comprising determining a longer one of the cell DME period of the first eDRX configuration and a cell DME period of the second eDRX configuration, selecting one of the first eDRX configuration and the second eDRX configuration having the longer cell DME period, continuing the ongoing cell DME operation based on the selected one of the first eDRX configuration and the second eDRX configuration; and, after the cell DME period for the selected one of the first eDRX configuration and the second eDRX configuration, performing subsequent DME operations for the NSC using the DME period based on the second eDRX configuration.

In a twentieth example, the method of the fifteenth example, wherein the change comprises an inter-eDRX transition on an original serving cell.

In a twenty first example, the method of the twentieth example, further comprising terminating the ongoing cell DME operation, wherein the terminating includes discarding any measurement samples collected during the ongoing cell DME operation and performing a new cell DME operation for a target neighbor cell during a new cell DME period based on the second eDRX configuration.

In a twenty second example, the method of the twentieth example, further comprising, when (i) the transition occurs during a legacy eDRX paging timing window (PTW), (ii) following the transition the UE is an enhanced eDRX PTW, or (iii) the second eDRX configuration does not include a PTW, continuing the ongoing cell DME operation for a target neighbor cell based on the second eDRX configuration, wherein samples collected prior to the transition using the first eDRX configuration are combined with samples collected after the transition using the second eDRX configuration and, after the cell DME period, performing subsequent DME operations for the target neighbor cell using a new DME period based on the second eDRX configuration.

In a twenty third example, the method of the twentieth example, further comprising determining a longer one of the cell DME period of the first eDRX configuration and a cell DME period of the second eDRX configuration, selecting one of the first eDRX configuration and the second eDRX configuration having the longer cell DME period, continuing the ongoing cell DME operation based on the selected one of the first eDRX configuration and the second eDRX configuration and after the cell DME period for the selected one of the first eDRX configuration and the second eDRX configuration, performing subsequent DME operations for a target neighbor cell using the DME period based on the second eDRX configuration.

In a twenty fourth example, a processor configured to perform any of the methods of the fifteenth through twenty third examples.

In a twenty fifth example, a user equipment (UE) comprising a transceiver configured to communicate with a network and a processor communicatively coupled to the transceiver and configured to perform any of the methods of the fifteenth through twenty third examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
perform a cell reselection procedure from an original serving cell to a target neighbor cell, wherein completion of the cell reselection procedure results in the target neighbor cell becoming a new serving cell (NSC), the cell reselection procedure comprising reading system information of the target neighbor cell, wherein the system information comprises an enhanced discontinuous reception (eDRX) configuration of the target neighbor cell;
monitor paging occasions for the original serving cell while performing the cell reselection procedure for the target neighbor cell; and
when the cell reselection procedure is complete, monitor paging occasions for the NSC based on the eDRX configuration from reading the system information of the target neighbor cell.

2. The apparatus of claim 1, wherein the system information comprises a system information block (SIB) transmitted by the target neighbor cell.

3. The apparatus of claim 2, wherein the SIB comprises SIB-1.

4. The apparatus of claim 1, wherein the system information comprises a master information block (MIB) target neighbor cell.

5. The apparatus of claim 1, wherein the cell reselection procedure further comprises cell detection of the target neighbor cell, cell measurement of the target neighbor cell, and cell evaluation of the target neighbor cell.

6. An apparatus comprising processing circuitry configured to:
perform an ongoing cell detection/measurement/evaluation (DME) operation during a cell DME period based on at least a first enhanced discontinuous reception (eDRX) configuration of a serving cell; and
determine a change from the first eDRX configuration to a second eDRX configuration, wherein the change occurs during the cell DME period.

7. The apparatus of claim 6, wherein the serving cell is an original serving cell and the change is based on a transition from the original serving cell to a new serving cell (NSC).

8. The apparatus of claim 7, wherein the processing circuitry is further configured to:
when the transition occurs during a legacy eDRX paging timing window (PTW), continue the ongoing cell DME operation for the NSC based on the second eDRX configuration, wherein samples collected prior to the transition using the first eDRX configuration are combined with samples collected after the transition using the second eDRX configuration; and
after the cell DME period, perform subsequent DME operations for the NSC using a new DME period based on the second eDRX configuration.

9. The apparatus of claim 7, wherein the processing circuitry is further configured to:
when, following the transition the paging timing window (PTW) is an enhanced eDRX PTW, continue the ongoing cell DME operation for the NSC based on the second eDRX configuration, wherein samples collected prior to the transition using the first eDRX configuration are combined with samples collected after the transition using the second eDRX configuration; and
after the cell DME period, perform subsequent DME operations for the NSC using a new DME period based on the second eDRX configuration.

10. The apparatus of claim 7, wherein the processing circuitry is further configured to:
when the second eDRX configuration does not include a paging timing window (PTW), continue the ongoing cell DME operation for the NSC based on the second eDRX configuration, wherein samples collected prior to the transition using the first eDRX configuration are combined with samples collected after the transition using the second eDRX configuration; and
after the cell DME period, perform subsequent DME operations for the NSC using a new DME period based on the second eDRX configuration.

11. The apparatus of claim 6, wherein the processing circuitry is further configured to:
determine a longer one of the cell DME period of the first eDRX configuration and a cell DME period of the second eDRX configuration;
select one of the first eDRX configuration and the second eDRX configuration having the longer cell DME period;
continue the ongoing cell DME operation based on the selected one of the first eDRX configuration and the second eDRX configuration; and
after the cell DME period for the selected one of the first eDRX configuration and the second eDRX configuration, perform subsequent DME operations for the NSC using the DME period based on the second eDRX configuration.

12. The apparatus of claim 6, wherein the change comprises an inter-eDRX transition on an original serving cell.

13. The apparatus of claim 12, wherein the processing circuitry is further configured to:
terminate the ongoing cell DME operation, wherein the terminating includes discarding any measurement samples collected during the ongoing cell DME operation; and
perform a new cell DME operation for a target neighbor cell during a new cell DME period based on the second eDRX configuration.

14. The apparatus of claim 12, wherein the processing circuitry is further configured to:
when (i) the transition occurs during a legacy eDRX paging timing window (PTW), (ii) following the transition the UE is an enhanced eDRX PTW, or (iii) the second eDRX configuration does not include a PTW,
continue the ongoing cell DME operation for a target neighbor cell based on the second eDRX configuration, wherein samples collected prior to the transition using the first eDRX configuration are combined with samples collected after the transition using the second eDRX configuration; and
after the cell DME period, perform subsequent DME operations for the target neighbor cell using a new DME period based on the second eDRX configuration.

15. The apparatus of claim 12, wherein the processing circuitry is further configured to:
determine a longer one of the cell DME period of the first eDRX configuration and a cell DME period of the second eDRX configuration;
select one of the first eDRX configuration and the second eDRX configuration having the longer cell DME period;
continue the ongoing cell DME operation based on the selected one of the first eDRX configuration and the second eDRX configuration; and
after the cell DME period for the selected one of the first eDRX configuration and the second eDRX configuration, perform subsequent DME operations for a target neighbor cell using the DME period based on the second eDRX configuration.

16. An apparatus comprising processing circuitry configured to:
process, based on signals received from an original serving cell, a neighbor cell list comprising information for each neighbor cell on the neighbor cell list;
perform cell detection, measurement, and evaluation for a target neighbor cell;
associate with the target neighbor cell, wherein the target neighbor cell becomes a new serving cell (NSC); and
determine whether the NSC is on the neighbor cell list.

17. The apparatus of claim 16, wherein the processing circuitry is further configured to:
when the NSC is on the neighbor cell list and when the information does not include an enhanced discontinuous reception (eDRX) configuration for the NSC, monitor paging occasions for the NSC based on an eDRX configuration for the original serving cell.

18. The apparatus of claim 16, wherein the processing circuitry is further configured to:
when the NSC is on the neighbor cell list and when the information does not include an eDRX configuration for the NSC, monitor paging occasions for the NSC based on a legacy eDRX configuration with a cycle periodicity of less than or equal to 10.24 seconds.

19. The apparatus of claim 16, wherein the processing circuitry is further configured to:
when the NSC is on the neighbor cell list and when the information does not include an eDRX configuration for the NSC, monitor paging occasions from the original serving cell until a system information reading of the NSC provides an indication of the eDRX configuration for the NSC.

20. The apparatus of claim 16, wherein the processing circuitry is further configured to:
when the NSC is on the neighbor cell list and when the information includes an eDRX configuration for the NSC, monitor paging occasions for the NSC based on the eDRX configuration for the NSC.
